(19) United States
(12) Patent Application Publication
(10) Pub. No.: US 2025/0389574 A1
(43) Pub. Date: Dec. 25, 2025

(54) MODULAR UTILITY CONTAINER AND SYSTEM FOR REAL-TIME LIQUID-LEVEL DETECTION

(71) Applicants: John M. Tursky, Hillsborough, NJ (US); Andrii Velhov, Somerset, NJ (US); Matthew Ruzicka, Jackson, NJ (US); Andrew J. Tursky, Gilbert, AZ (US)

(72) Inventors: John M. Tursky, Hillsborough, NJ (US); Andrii Velhov, Somerset, NJ (US); Matthew Ruzicka, Jackson, NJ (US); Andrew J. Tursky, Gilbert, AZ (US)

(21) Appl. No.: 19/063,113

(22) Filed: Feb. 25, 2025

Related U.S. Application Data
(63) Continuation-in-part of application No. 18/825,150, filed on Sep. 5, 2024.
Application No. 18/825,150 is a continuation-in-part of application No. 18/747,848, filed on Jun. 19, 2024, now Pat. No. 12,458,162.

(51) Int. Cl. G01F 23/296; B65D 1/02; B65D 23/00; G01F 25/20

(52) U.S. Cl. CPC G01F 23/296; B65D 1/0276; B65D 23/006; G01F 25/20

(57) ABSTRACT

A modular utility container 112 comprises a hollow body 112 for storing a liquid through an opening 116 formed at a top end of the hollow body 114. A neck 118 extends from the opening 116 and has a narrower cross-section than hollow body 114 and a tapered-shaped structure. Container 112 further comprises a base 122 supporting the hollow body 112. Base 122 is made substantially curved in an inward dome-shaped structure, configured to engage with a sensor 206 to determine the level of liquid present within utility container 112. Container 112 is configured for use with a real-time liquid-level detection system 300 to eliminate manual monitoring of utility container 112 for determining the liquid level, and details regarding the liquid level of fluid stored in utility container 112 are assessed via a remote means and an inbuilt mobile application. Base 122 has a concave punt with a central flat indentation that enhances the usability and accuracy of ultrasonic liquid level measurement in aluminum bottles. Sensor 206 is, optionally, convex and deforms in response to downward pressure from base 206 to establish contact with substantially all points of engagement. The system ensures stable and repeatable sensor positioning, eliminates air gaps and wave distortions, improves operational efficiency in hotel housekeeping, and maintains bottle strength and manufacturing feasibility.

### CROSS-REFERENCE TO RELATED APPLICATIONS

This application is a continuation in part of U.S. patent application Ser. No. 18/825,150, filed on Sep. 5, 2024, which, in turn, is a continuation in part of Ser. No. 18/747,848, entitled “UTILITY HOLDER,” filed on Jun. 19, 2024, the disclosures of which are hereby incorporated in their entireties by reference thereto.

### BACKGROUND OF THE INVENTION

### 1. Field Of The Invention

The present invention relates to the field of utility items and, more particularly, to a modular utility container and a system for real-time liquid level detection, which facilitates determining the level of liquids present in containers.

### 2. Description Of The Prior Art

Utility holders are the most versatile and practical solutions designed to securely store and organize a variety of items, including household or commercial items. These holders come in various forms, such as wall-mounted racks, adhesive hooks, and freestanding structures tailored to different environments and needs. Such holders are made from durable materials like stainless steel, plastic, or rubber to ensure stability and longevity. Their design often includes features like adjustable and non-slippery attachments to accommodate items of different sizes and weights. These holders reduce space utilization by keeping the items neatly arranged and easily accessible. Such a holder contributes to a more organized and good ambiance working environment.

For example, a liquid dispenser holder is often used in various domestic as well as public facilities. These dispenser holders are available in the markets in different forms and are made from different durable materials. Such dispenser holders are used very commonly in homes, schools, offices, hotels, and restaurants to secure liquid soap, shampoo, and conditioner dispensers, among others. Such holders typically have a fixed structure and accommodate only specific-sized dispensers; this increases costs when replacements are needed. They also lack proper safeguards against unauthorized removal, which is crucial in public facilities.

To address the above issues, non-refillable bottles have been used, which are further disposed of after use, leading to significant waste and high costs. To address such problems, hotels, offices, and public facilities have begun to utilize refillable metallic bottles made of steel, aluminum, and the like. While the aluminum bottles represent a step forward in reducing disposal waste, their opaque nature raises new challenges for housekeeping staff. Due to the opaque condition of aluminum bottles, it is oftentimes difficult to determine the level of liquids present in the containers holding them. Also, one must repeatedly open the container after specific intervals to refill the containers; this manual refilling step is a very tedious and cumbersome task.

Housekeeping staff find it difficult to accurately gauge the remaining liquid levels, making manual inspections cumbersome and prone to error. This inefficiency complicates inventory management and impacts user satisfaction. Precise tracking of liquid levels is crucial for maintaining optimal stock levels. Without accurate refilling indicators, it becomes challenging to manage inventory effectively, potentially resulting in overstocking or stock-outs.

There accordingly exists a need to develop some means that accurately measure and indicate liquid levels in dispensers to improve inventory management and ensure optimal stock levels. Such means should also be efficient, and cost-effective to reduce significant wastage and expenses on non-refillable bottles.

### OBJECTIVES OF THE INVENTION

The principal object of the present invention is to improve by addressing the limitations of existing containers and liquid-level detection systems previously used in the hotel industry.

Another objective of the present invention is to develop a container that is reusable and lightweight.

Another objective of the present invention is to develop a container to be utilized for the storage of different liquids, such as liquid soaps and/or beverages.

Another objective of the present invention is to develop a container that is durable and can withstand rough handling conditions.

A further objective of the present invention is to develop a container that prevents spillage of the stored liquid, thereby eliminating wastage and reducing material costs.

A further objective of the present invention is to develop a system that provides a mechanism for remote access to the details of the liquid level.

Yet another objective of the present invention is to develop a container that has an ergonomic design, ensuring space optimization.

Still another objective of the present invention is to develop a method and means that accurately measure and indicate liquid levels in dispensers to improve inventory management and ensure optimal stock levels;

Still a further objective of the present invention is to develop a method and means for accurately measuring and indicating liquid levels in dispensers, which are efficient and cost-effective, and reduce significant wastage and expenses on non-refillable bottles.

The foregoing and other objects, features, and advantages of the present invention will become readily apparent upon further review of the following overview and description of the preferred embodiment as illustrated in the accompanying drawings.

### SUMMARY OF THE INVENTION

This section provides a general summary of the disclosure and is not a comprehensive disclosure of the full scope of all its features.

In particular, the present invention relates to a modular utility container and a system for real-time liquid level detection that not only provides real-time liquid level detection but also offers a mechanism for remotely accessing the details of the liquid level present in the container while enabling effective and efficient inventory management.

One aspect of the present invention is a modular utility container for liquid-level detection. Said container has a hollow body adapted to store a liquid having a neck region with an opening and a closed base to support said hollow body. Said neck region, extending from said hollow body, has a narrower cross-section than said hollow body. The base of the hollow body is substantially curved inwards and configured to engage with a sensor to determine the level of liquid present within said container.

In an embodiment of the present invention, the container further includes a lid to cover/close the opening of the hollow body.

In another embodiment, the lid includes a sealing medium that seals the opening to prevent leaks and spillage of stored liquid such as liquid soap and/or beverages like beer, wine, oil, and the like.

In another embodiment, said base of the container forms an inward dome-shaped structure.

In another embodiment, the container is of different cross-sectional dimensions and heights.

In a further embodiment of the present invention, the container is reusable and opaque.

According to a further aspect of the present invention, a liquid-level detection system comprises a dispenser holder accommodated with a container having a base formed in an inward dome-shaped structure configured to engage with a sensor. The sensor is preferably located precisely in the center of the bottle's bottom, and its shape is congruent with the shape of the bottle's bottom at substantially all points of engagement. A hand-held device integrated with the sensor to determine the level of liquid present in the utility container. A control unit is installed in the handheld device and is configured to establish a direct connection between the sensor and the user interface of the handheld device to notify the authorized personnel about the determined level of liquid present in the container.

According to a further embodiment of the present invention, the container is secured by a holding bracket, which is attached to the dispenser holder and is adjustable to accommodate the cross-sectional dimensions and height of the utility container.

In another embodiment, the user interface can be a display screen of a user device such as a smartphone or laptop.

In another embodiment, the control unit further comprises a processing module and a communication module that establishes a wireless connection between the hand-held device and the user device to remotely notify the user about the level of liquid present in the utility container via a remote server for inventory management. In an embodiment of the present invention, the communication module is a Wi-Fi module or NFC Tag and a Bluetooth module.

In a further embodiment, the sensor configured to engage with the inward dome is an ultrasonic sensor.

In a further embodiment, at least a portion of the inward dome is flat, and the ultrasonic sensor appointed for engagement with the inward dome has a convex configuration, whereupon downward pressure applied to the ultrasonic sensor by the flat portion of the inward dome brings the ultrasonic sensor into contact with the inward dome at substantially all points of engagement.

In a further embodiment, the processing module is a microcontroller, which is specifically an Arduino Nano 33 BLE microcontroller.

In another embodiment, the handheld device is powered by a rechargeable battery.

In yet another embodiment of the present invention, the handheld device includes a calibration feature for calibrating the sensor to match the container's dimensions in real time and for precise measurement of liquid stored inside the container.

Other features, benefits, and advantages of the present invention will be apparent upon a review of the present disclosure, including the specification, abstract, and claims.

### BRIEF DESCRIPTION OF THE DRAWINGS

The invention will be more fully understood, and further advantages will become apparent when reference is had to the following detailed description of the preferred embodiments of the invention and the accompanying drawings, in which:

FIG. 1A illustrates a perspective view of a dispenser holder in accordance with an embodiment of the present invention;

FIG. 1B illustrates a perspective view of a modular utility container held in the dispenser holder of FIG. 1, in accordance with an embodiment of the present invention;

FIG. 1C illustrates a sectional view of the modular utility container of FIG. 1B, in accordance with an embodiment of the present invention;

FIG. 1D illustrates an embodiment of the modular utility container of FIG. 1B, having a flat surface formed in the curved base of the utility container, in accordance with an embodiment of the present invention.

FIG. 2 illustrates a perspective view of a handheld device in accordance with an embodiment of the present invention.

FIG. 3 illustrates a front view of a real-time liquid-level detection system.

### DETAILED DESCRIPTION OF THE INVENTION

The embodiments herein and the various features and advantageous details are explained more fully with reference to the non-limiting embodiments illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in the application, as all equivalents, synonyms, new developments, and terms or techniques that serve the same or a similar purpose are considered to be within the scope of the subjoined claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

As used herein, the term “or” includes “and/or” and the term “and/or” includes any and all combinations of one or more of the associated listed items. Expressions such as “at least one of” when preceding a list of elements modify the entire list of elements and do not modify the individual elements of the list.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The growing adoption of recyclable aluminum bottles in industries such as hospitality has introduced new challenges in measuring liquid levels accurately. Traditional plastic containers allow for easy visual inspection, but opaque aluminum bottles require a non-contact sensing solution for liquid-level detection. Ultrasonic sensors offer a viable approach, but their effectiveness is highly dependent on the bottle's bottom geometry. In accordance with the present invention, this problem has been overcome through the use of a modified concave punt design comprising a circular flat indentation at its lowest point. This design improves sensor accuracy, repeatability, and ease of use, ensuring reliable liquid-level detection.

It has also been found that flat-bottom aluminum bottles provide enhanced sensor contact, promoting a uniform ultrasonic coupling for accurate measurements. However, structural limitations, including pressure resistance, dent susceptibility, and the like, make flat-bottom aluminum bottles somewhat less practical for real-world applications, particularly in pressurized or frequently handled environments.

To overcome these issues, the present invention provides a novel punt configuration comprising a flat circular indentation for precise sensor coupling. An innovative concave punt design in accordance with an embodiment of the present invention incorporates a small, centrally located circular indentation with a perfectly flat segment. This design facilitates a stable ultrasonic sensor placement while retaining the structural advantages of a concave punt.

Key features of the punt configuration of the present invention include: (i) a flat circular segment that provides a defined coupling zone. The center of the concave punt comprises a flat circular area with dimensions optimized for ultrasonic sensor coupling. The flat circular segment removes curvature-induced signal distortion while providing a repeatable and reliable contact point for the sensor; (ii) convex ultrasonic gel pad compatibility: the use of an optional convex-shaped ultrasonic gel pad further enhances coupling by filling any micro-gaps. Under applied force, the gel pad deforms into a flat interface, ensuring maximum ultrasonic wave transmission; (iii) Precision Positioning for Housekeeping Staff: the flat segment serves as a natural alignment guide, allowing hotel housekeeping staff to quickly and consistently position the measurement device. Human error in sensor placement is eliminated, making the device more user-friendly: (iv) Structural Integrity Retention and Stacking Benefit: Unlike fully flat-bottom designs, the concave punt continues to provide mechanical strength to the bottle. The flat circular segment is small enough that the structural integrity or stacking efficiency of the bottle is uncompromised.

Significant advantages are incorporated into the element combination of the present invention. (i) Air Gaps are eliminated for Accurate Readings: traditional concave punts introduce an air gap issue when coupling ultrasonic sensors. The flat circular segment optionally comprising a convex-shaped ultrasonic gel pad ensures direct sensor contact, eliminating errors caused by wave reflection distortions. (ii) Improved Measurement Repeatability: The flat segment acts as a dedicated sensor placement zone, ensuring that each measurement occurs under substantially the same conditions. Data consistency is improved, particularly for automated inventory management systems. (iii) Reduces Training and Operational Errors: Standard concave punts lack a precise reference point for sensor placement. By incorporating a flat segment, housekeeping staff can instantly locate the correct measurement position, reducing the risk of incorrect readings. (iv) Compatible with Existing Manufacturing Processes: While fully flat-bottom bottles require major production adjustments, the flat circular segment can be easily integrated into existing concave punt designs with minimal tooling modifications.

These aspects of the punt configuration of the present invention commend it for use in connection with a modular utility container comprising a real-time liquid level detection system designed to detect real-time liquid levels present in containers by eliminating the need for manual inspections, thus enhancing efficiency and accuracy in inventory control and management.

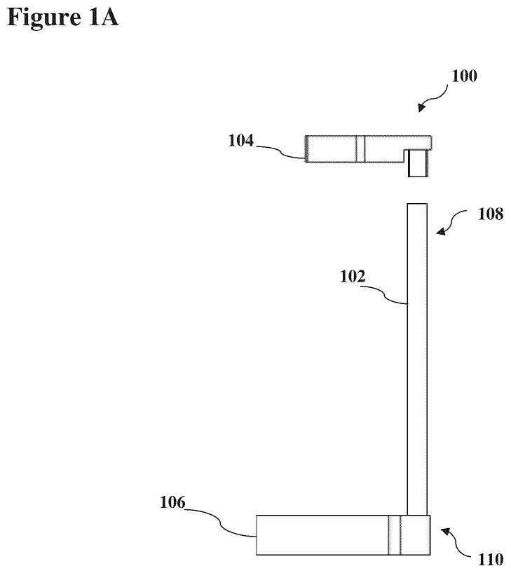

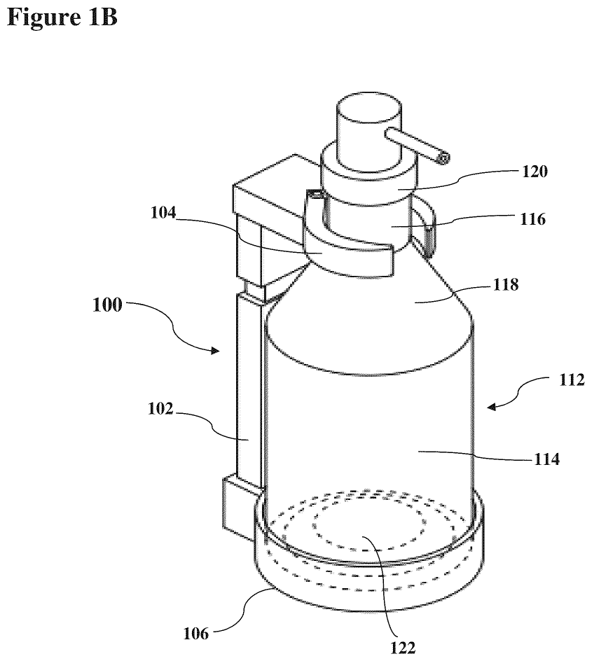

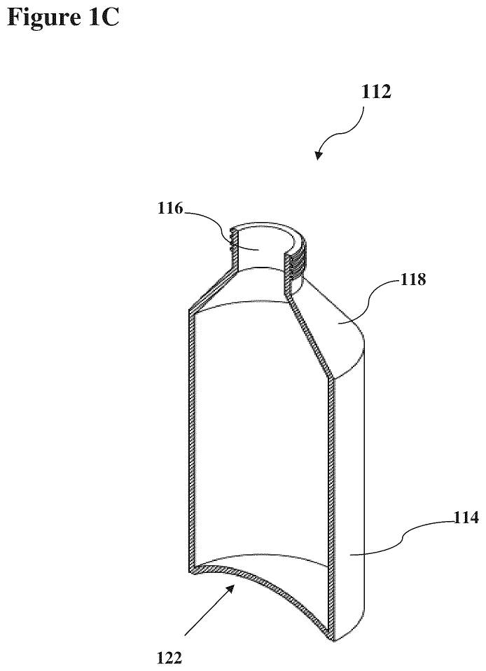

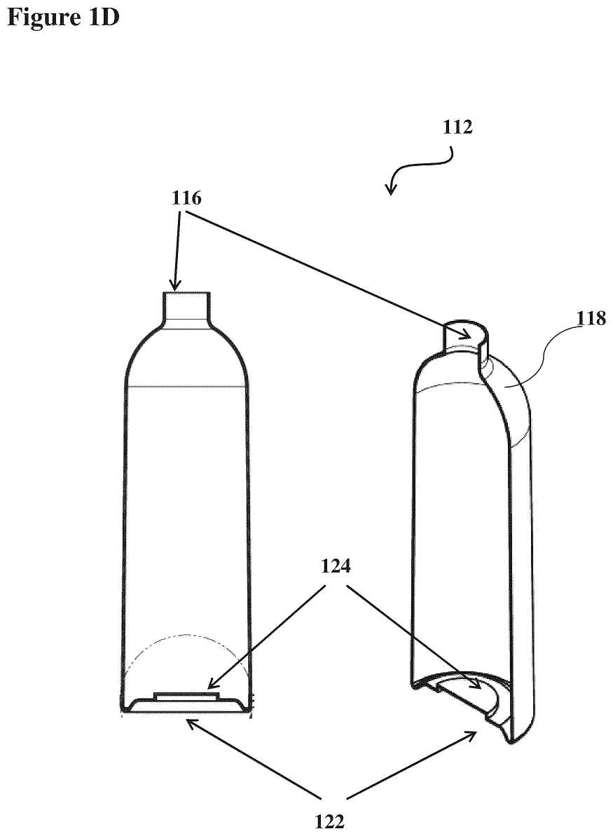

FIGS. 1A and 1B illustrate a perspective view of a dispenser holder and a modular utility container held for liquid-level detection accommodated in the dispenser holder. The dispenser holder 100 comprises a frame 102 affixed with a fixture clamp 104 and a holding bracket 106. The frame 102 is an elongated entity which may be rigid or hollow in construction. The frame 102 possesses a cuboidal-shaped bar structure and is adapted to be mounted on a wall. The frame 102 includes a top-end 108 and a bottom-end 110. At the top end 108, the fixture clamp 104 is affixed, while at the bottom end 110, the holding bracket 106 is attached for the accommodation of a modular utility container 112, hereinafter referred to as utility container 112 (as illustrated in FIG. 1B).

Further, frame 102 joins the fixture clamp 104 and holding bracket 106 so that the fixture clamp 104 and holding bracket 106 collaboratively grip the utility container 112 therebetween (as depicted in FIG. 1B). In an embodiment, the fixture clamp 104 has a semi-circular shape which provides a firm grip on the utility container 112. In another embodiment, the frame 102 and the fixture clamp 104 are adjustable in configuration to accommodate different-sized containers.

FIG. 1B illustrates that utility container 112 comprises a hollow body 114 that possesses a substantially cylindrical shape with a circular cross-section. The hollow body 114 is made up of any material selected from a group of metallic and/or plastic materials and the like. In an embodiment, the hollow body 114 of the utility container 112 is opaque and is made from a reusable material. In another embodiment, the utility container 112 is of different cross-sectional dimensions and heights.

In an embodiment of the present invention, the lid 120 includes a sealing medium (not shown here), which is adapted to seal the opening 116 of the hollow body 114 to prevent leaks and spillage of filled liquid. The stored/filled liquid may be liquid soap and/or beverages, such as beer, wine, oil, and the like. In an embodiment, the sealing medium may be a gasket, any rubberized washer, or maybe any air-tight seal.

Moreover, utility container 112 comprises a base 122 that supports the hollow body of utility container 112 filled with any of the aforementioned liquids. In an embodiment, base 122 is formed in a substantially curved shaped structure, which is an inward dome-shaped structure (as illustrated in FIG. 1B and IC) configured to engage with a sensor for determination of the level of liquid present within the utility container 112. Base 122 provides an upright orientation to container 112, with the opening 116 facing upwards to allow the filing of container 112 with the base 122 facing downwards.

In another embodiment, the base 122 of container 112 may be formed with a flat-shaped surface 124 (as illustrated in FIG. 1D). The flat surface 124 formed in the center of the domed-shaped base 122 of container 112, is shown in FIG. 1D.

FIG. 1C illustrates a sectional view of the utility container 112. The dome-shaped structure of base 122 is identifiable and includes a curvature forming the inward dome structure. The curvature of the inward dome allows the sensor of a handheld device (not shown here) to be engaged appropriately to determine the level of liquid present within the utility container 122. It is preferred that the sensor be located precisely in the center of the bottle's bottom and that its shape be congruent with the shape of the bottle's bottom at substantially all points of engagement. The sectional view of utility container 112 also depicts the internal structure and construction of base 122, neck 118, and opening 116 of utility container 112.

An opening 116 is provided in the top portion of the hollow body 114, which is utilized to store/fill a liquid inside the utility container 112 (as indicated in FIG. 1B). The opening 116 is formed in a manner that a neck 118 (as illustrated in FIG. 1B) extends from the opening 116 and has a tapered shape with a narrower cross-section than the hollow body 114, providing the utility container 112 an aesthetic appearance and/or a shape of a bottle-like entity (as depicted in FIG. 1B). Further, with the opening 116, a lid 120 is provided for covering the utility container 112 from the top end to cover/close the opening 116 of hollow body 114.

FIG. 1D illustrates different views of the utility container 112 in accordance with another embodiment of the present invention. The dome-shaped base 122 is identifiable and includes the flat-horizontal surface 124 in the center portion of base 122. The flat surface 124 resembles a flat-horizontal depression-like structure. The flat surface of base 122 allows the sensor of a handheld device (not shown here) to appropriately engage with base 122 to determine the level of liquid present within the utility container 112. This configuration of flat-surface 124 within the curved base 122 enables the sensor to be located in the exact center of base 122 of container 124. The shape of such flat-surface 124 is congruent with the shape of the sensor, at substantially all points of engagement.

The curvature area of the domed-shaped base 122 is eliminated due to the presence of flat-surface 124, which reduces the signal distortion and provides a repeatable and reliable contact point for the sensor. The flat surface 124 in base 122 serves as a natural alignment guide, allowing the housekeeping personnel to quickly position the handheld device 200 under base 122 of container 112 to determine the level of liquid soap inside container 112. This in turn eliminates human error while placing the sensor of the handheld device 200 and makes the handling of the handheld device 200 more user-friendly.

Flat-surface 124 in base 122 provides mechanical strength to container 112 and increases its structural integrity. Additionally, the flat-surface 124 allows stacking of multiple containers 112 one over another very conveniently, thereby reducing space consumption of the containers 112 during storage.

The sectional view of utility container 112, as illustrated in FIG. 1D, also depicts the internal structure and construction of base 122 and illustrates the positioning of the flat-surface 124 with the domed-shaped base 122, the neck 118, and the opening 116 of utility container 112.

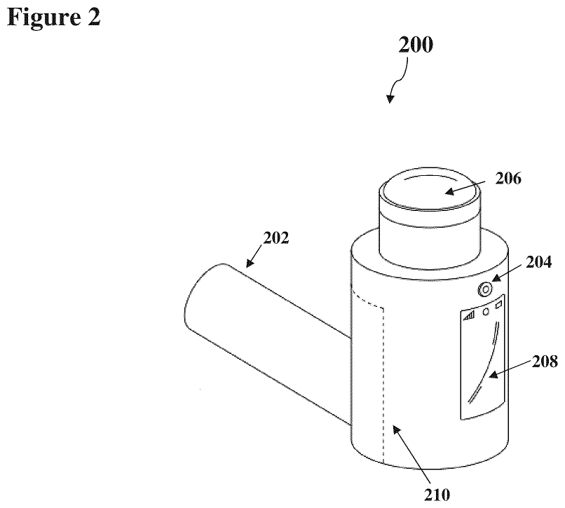

FIG. 2 illustrates a perspective view of the handheld device 200. As shown, handheld device 200 comprises a handle 202, which allows convenient handling of the handheld device 200 while engaging with the inward dome structure of the base 122 (illustrated in FIG. 1C). A push button 204 is operative to switch “ON” and “OFF” the handheld device 200. Sensor 206, integrated with the handheld device 200, determines the level of liquid stored/filled in the utility container 112. A control unit (not shown) is embedded in the handheld device 200 and configured to establish a connection between the sensor 206 and a user-interface 208 of the handheld device 200 to provide visual readings about the determined level of liquid present in the utility container 112. Further, the handheld device 200 comprises a slot 210 for the installation of a rechargeable battery for convenient operation.

The handheld device 200 is designated to measure the levels of the liquid stored/filled within one or more utility containers 112, each of which is opaque (as disclosed in FIG. 1), utilizing the integrated sensor 206. These opaque utility containers 112 may include aluminum bottles, beer kegs, oil drums, etc. In an embodiment, the sensor 206 utilized in the handheld device 200 to detect liquid level is an ultrasonic sensor. In a preferred embodiment, the ultrasonic sensor is a DYPL02 Ultrasonic Liquid Level Sensor. In an embodiment, sensor 206 has a convex shape and is deformable upon the application of downward pressure by utility container 112.

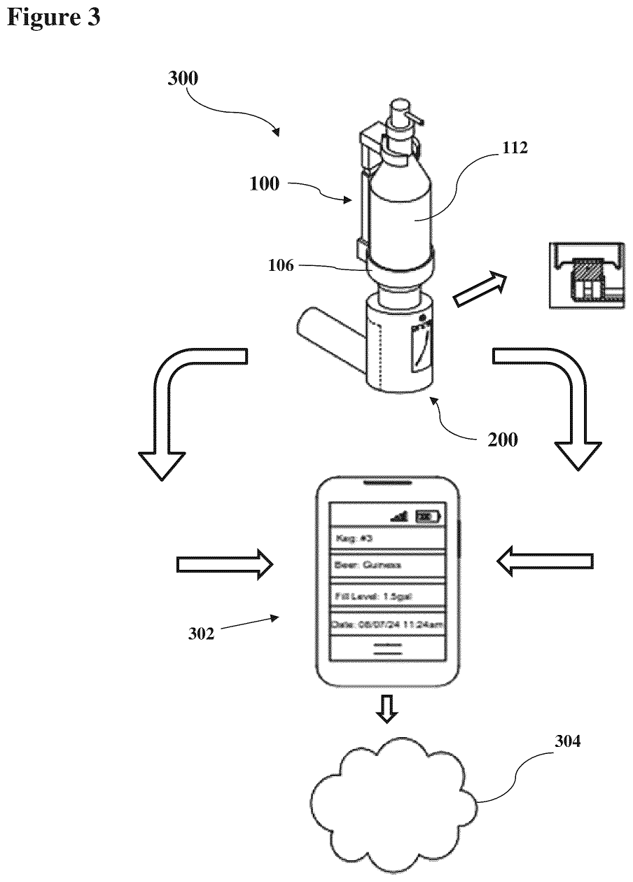

FIG. 3 illustrates a liquid level detection system wherein system 300 includes the dispenser holder 100 accommodated with the utility container 112 filled with any of the liquid (as disclosed before). In an embodiment, the utility container 112 is held in the dispenser holder 100 via the holding bracket 106 of the dispenser holder 100. In another embodiment, holding bracket 106 is adjustable according to the cross-sectional dimensions and height of the utility container 112.

Further, in FIG. 3, the utility container 112 comprises base 122 having an inward dome shape, or a flat-surface bottom, engaged with the hand-held device 200. This, in turn, engages the sensor 206 integrated with the hand-held device 200 and the base 122 of container 112 to initiate liquid-level detection of the utility container. It is preferred that sensor 206 is located precisely in the center of base 122 of container 112, such that the shape of sensor 206 is congruent with the shape of base 122 of container 112 to engage at substantially all points of base 122. Preferably, sensor 206 has a convex shape that deforms upon application of downward pressure from container 112 to establish contact therewith at substantially all points of engagement.

Once the handheld device 200 is placed against the base of container 122 and the sensor 206 engages with the base 122, the sensor 206, which is a DYPL02 Ultrasonic Liquid Level sensor, activates to emit ultrasonic waves within the utility container 112. The waves passing through base 122 strike with the liquid surface level and reflect back to the ultrasonic sensor, facilitating the accurate distance measurement between sensor 206 and the fluid surface.

The DYPL02 Ultrasonic Liquid Level sensor 206 is embedded with small transducers that generate and receive high-frequency ultrasonic waves. The time-of-flight of these waves, after striking the liquid level, is analyzed to determine and provide real-time, reliable data regarding the volume/level of the liquid present inside the utility container 112. The detected data from the ultrasonic sensor 206 is further transmitted to the control unit and integrated into the handheld device 200 for processing the detected data.

The control unit comprises a processing module that analyses the ultrasonic signals by employing advanced algorithms to determine the precise liquid level inside container 202. After analyzing the received signals, the processing module converts the analog signals to a digital output to decode the time-of-flight data of reflected ultrasonic waves. The conversion from analog to digital signals ensures high-resolution liquid-level data, which is further formatted for integration with digital systems to display the text readings.

The processing module for decoding the signals accurately represents the real-time liquid level present within container 202. In an embodiment, the processing module is a microcontroller, which is specifically an Arduino Nano 33 BLE microcontroller.

On determining the level of liquid inside utility container 112, the control unit activates a user interface 208 of the handheld device 200 to display the detected data in the form of text readings to notify authorized personnel about the determined level of liquid in utility container 112. In an embodiment, the user interface 208 is a visual display screen of the handheld device 200.

Further, the control unit includes a communication module that establishes a wireless connection between the hand-held device 200 and a user device 302 of the authorized personnel via a remote server. This remote connection with the control unit allows the authorized personnel to remotely access the details about the level of liquid present in the utility container 112 over a cloud network 304 through an inbuilt application. Remote access to the server allows the authorized person to access the detected level of liquid from a distant location. In an embodiment, the user device 302 is a cart used by personnel for housekeeping operations within the hospitality industry.

In an embodiment, the inbuilt application of user-device 302, named Bottle VSN application, has a user-friendly interface and enables authorized personnel to maintain the stocks during inventory management via the cloud network 304. The Bottle VSN application includes various tabs, widgets, navigation menus, etc., which enable the authorized personnel to manage the overall notifications activities and control the operation of the dispenser holder 100 and the container 112.

In an embodiment, the communication module may use wireless technologies such as Wi-Fi, Bluetooth, NFC tag, or cellular networks to facilitate seamless data transfer over a network. It encodes the digital signals into packets suitable for wireless transmission, ensuring reliable and efficient communication between the processing module and the server. The server then receives, stores, and processes the data for further analysis.

In a further embodiment, the handheld device 200 includes a calibration feature for calibrating the sensor 206 to match the dimensional configuration of base 122 of the different types of containers, for precise and real-time measurement of liquid stored within the container. The calibration feature may include the facility of adjusting the sensitivity of the ultrasonic sensor, and the wave intensity.

An implementation of the liquid level measuring system of the present invention comprises the following steps. (i) a member of the housekeeping staff places the handheld measurement device against the bottle's bottom; (ii) the sensor aligns with the flat circular segment, ensuring ideal coupling without requiring precise manual adjustments; (iii) an ultrasonic pulse is transmitted, and the liquid level is accurately detected; (iv) data regarding the level of liquid in the bottle is sent via Bluetooth to an inventory management system, updating refill requirements in real-time.

Advantageously, using a concave punt with a central flat indentation significantly enhances the usability and accuracy of ultrasonic liquid level measurement in aluminum bottles. In accordance with the present invention, this configuration ensures stable and repeatable sensor positioning, eliminates air gaps and wave distortions, improves operational efficiency in hotel housekeeping, and maintains bottle strength and manufacturing feasibility.

By addressing the limitations of standard concave punts, the modular utility container for real-time liquid level detection bridges the gap between practical bottle design and advanced ultrasonic sensing technology, making it a game-changer for the hospitality and refillable container industries.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within understood that the phraseology or the terminology employed herein is for description and not of limitation. Therefore, while the embodiments herein have been described in terms of preferred embodiments, those skilled in the art will recognize that the embodiments herein can be practiced with modification within the spirit and scope of the appended claims.

The advantages set forth above, and those made apparent from the foregoing description, are efficiently attained. Since certain changes may be made in the above construction without departing from the scope of the invention, it is intended that all matters contained in the foregoing description as illustrative and not in a limiting sense.

It is also to be understood that the following claims are intended to cover all the generic and specific features of the invention herein described, and all statements of the scope of the invention that, as a matter of language, might fall there within.

What is claimed is:

1) A modular utility container for liquid-level detection, comprising:
a hollow body adapted to store a liquid having a neck region with an opening and a closed base to support said hollow body, wherein said neck region is of narrower cross-section than said hollow body,
wherein said base is substantially curved inwards, and configured to engage with a sensor to determine the level of liquid present within said container.

2) The utility container of claim 1, further comprising a lid to close said opening of the neck region.

3) The utility container of claim 2, wherein said lid includes a sealing medium adapted to seal the opening of the container to prevent spillage of stored liquid.

4) The utility container of claim 1, wherein said stored liquid is selected from liquid soap and beverages.

5) The utility container of claim 1, wherein said base forms an inward dome-shaped structure.

6) The utility container of claim 1, wherein said container is of different cross-sectional dimensions and heights.

7) The utility container of claim 1, wherein said container is reusable.

8) The utility container of claim 1, wherein said container is made up of material substantially opaque.

9) The utility container of claim 1, said base having a punt configuration comprising:
a flat circular concave punt segment that provides a defined coupling zone, the center of said concave punt having a flat circular area with dimensions optimized for coupling with an ultrasonic sensor;
whereby said flat circular concave punt segment removes curvature-induced signal distortion while providing a repeatable and reliable contact point for said ultrasonic sensor.

10) The utility container of claim 9, said base being configured for use with a convex-shaped ultrasonic gel pad to enhance coupling by filling micro-gaps between said sensor and said flat circular area.

11) The utility container of claim 10, said gell pad, being configured to deform into a flat interface with said flat circular area of said concave punt segment in response to the application of downward pressure from said flat circular concave punt segment of said base, thereby providing maximum ultrasonic wave transmission.

12) The utility container of claim 11, said circular concave punt of said base segment being configured to provide an alignment guide, allowing hotel housekeeping staff to quickly and consistently position said base with said sensor.

13) The utility container of claim 11, the flat circular concave punt segment being configured to be congruent with the shape of the sensor, at substantially all points of engagement.

14) The utility container of claim 11, the convex shape of said sensor deforming upon application of downward pressure from the container to establish contact therewith at substantially all points of engagement.

15) A liquid-level detection system, comprising:
a dispenser unit for holding a container having a base formed in an inward dome-shaped structure configured to engage with a sensor;
a hand-held device integrated with said sensor to determine the level of liquid present within said container;
a control unit integrated into said handheld device, configured to establish a connection between said sensor and a user interface of said handheld device to notify about the determined level of liquid present in said container.

16) The system of claim 15, wherein said container is secured via a holding bracket attached to said dispenser unit.

17) The system of claim 16, wherein said holding bracket is adjustable in accordance with said cross-sectional dimensions and height of said container.

18) The system of claim 15, wherein said user interface may be a display screen of a user device comprising a smartphone or laptop.

19) The system of claim 15, wherein said control unit further comprises a processing module and a communication module that establishes a wireless connection between the hand-held device and said user-device to remotely notify the user about the level of liquid present in said container.

20) The system of claim 18, wherein said user-device receives signals from said communication module via a remote server provided in said system for inventory management.

21) The system of claim 18, wherein said sensor is an ultrasonic sensor.

22) The system of claim 19, wherein said processing module is a microcontroller.

23) The system of claim 22, wherein said microcontroller is an Arduino Nano 33 BLE microcontroller.

24) The system of claim 18, wherein said handheld device is powered by a rechargeable battery.

25) The system of claim 20, wherein said communication module is a Wi-Fi module or NFC Tag and a Bluetooth module.

26) The system of claim 18, wherein said handheld device includes a calibration feature for calibrating said sensor to match said container's dimensions for precise and real-time measurement of liquid stored inside said container.

27) The system of claim 15, said base having a punt configuration comprising:
a flat circular concave punt segment that provides a defined coupling zone, the center of said concave punt having a flat circular area with dimensions optimized for coupling with an ultrasonic sensor;
whereby said flat circular concave punt segment removes curvature-induced signal distortion while providing a repeatable and reliable contact point for said ultrasonic sensor.

28) The system of claim 27, said base being configured for use with a convex-shaped ultrasonic gel pad to enhance coupling by filling micro-gaps between said sensor and said flat circular area.

29) The system of claim 28, said gell pad, being configured to deform into a flat interface with said flat circular area of said concave punt segment in response to the application of downward pressure from said flat circular concave punt segment of said base, thereby providing maximum ultrasonic wave transmission.

30) The system of claim 29, said circular concave punt of said base segment being configured to provide an alignment guide, allowing hotel housekeeping staff to quickly and consistently position said base with said sensor.

31) The system of claim 30, the flat circular area of said concave punt segment being operative in response to downward pressure from said base to become congruent with the shape of the sensor at substantially all points of engagement.

32) The system of claim 30, the convex shape of said sensor deforming upon application of downward pressure from the container to establish contact therewith at substantially all points of engagement.
